(19) United States
(12) Patent Application Publication
(10) Pub. No.: US 2015/0065011 A1
(43) Pub. Date: Mar. 5, 2015

(54) Diamond Cutting Tool for Plastic Ornamentation and Method Thereof

(71) Applicant: Jonathan Mandelbaum, Port Washington, NY (US)

(72) Inventor: Jonathan Mandelbaum, Port Washington, NY (US)

(21) Appl. No.: 14/012,022

(22) Filed: Aug. 28, 2013

(51) Int. Cl. B44C 1/22; B24D 3/08; B44C 1/00

(52) U.S. Cl. CPC B44C 1/222; B44C 1/005; B24D 3/08
USPC 451/28; 451/177

(57) ABSTRACT

A method of using a diamond cutting tool for ornamentation purpose is provided. The method includes positioning a work piece in proximity to a cutting tool. The cutting tool includes a shank. Further, the cutting tool may extend longitudinally from the shank and coaxial therewith. The cutting end includes a cutting end comprised of, but not limited to, a compact mass of sharp diamond dust. Further, the method includes activating the cutting tool to perform one of cutting and polishing of at least a portion of the work piece. Herein, activating the cutting tool enables movement of the cutting tool for positioning thereof. Further, activating the cutting tool may enable spinning of the cutting end to perform one of cutting and polishing of a portion of the work piece based on the positioning of the cutting tool.

### FIELD OF THE INVENTION

Embodiments of the present invention relates to a diamond cutting tool and method of using the diamond cutting tool for plastic ornamentation. The method provides shinier plastic surface to prepare attractive and interesting ornaments.

### BACKGROUND OF THE INVENTION

Conventionally, plastic ornamentation is done by molding the plastic material by providing heat treatment. Further, the plastic material is cut or can be given a shape through various treatments such as simple flaming, drilling, cutting using cutter and the like. However, such treatments involve the risk of warping problem. For example, excess heat distorts the shape of the plastic. Usage of drilling equipment involves a risk of breakage or deformation in the plastic. Similarly, cutting by a cutter is performed manually and thus involves imprecision issue in shaping the plastic.

Further, the plastic material can be polished by using a simple flaming method or by using a scrapper for scrapping the edges. However, such techniques include the risk of deformation of the plastic material without providing the required finishing to the plastic. Further, manual scrapping of a plastic requires a significant effort and time on user's behalf.

Based on the afore-mentioned, an efficient tool and a corresponding method for usage of the tool are required for ornamentation of a plastic material by overcoming the drawbacks of existing techniques.

### SUMMARY OF THE INVENTION

Embodiments of the present invention provide a method of using a cutting tool for ornamentation purpose. The method may include positioning a work piece in proximity to a cutting tool. The cutting tool may include a shank and a cutting end. The cutting end is comprised of, but not limited to, a compact mass of sharp diamond dust. The cutting end extends longitudinally from the shank and coaxial therewith. Further, the method includes activating the cutting tool to perform one of cutting and polishing of at least a portion of the work piece. Herein, activating the cutting tool enables movement of the cutting tool for positioning thereof, and spinning of the cutting end to perform one of cutting and polishing of a portion of the work piece based on the positioning of the cutting tool. Herein, the work piece may include a plastic material.

Further, embodiments of the present invention provide a diamond cutting tool for an ornamentation purpose. The diamond cutting tool may include a shank and a cutting end. Further, the cutting end comprised of a compact mass of sharp diamond dust. The cutting end extends longitudinally from the shank and is coaxial therewith. The cutting end may include a curvy portion and a pointed tip portion. Herein, the pointed tip portion extends longitudinally from the curvy portion. The pointed tip portion adapted for cutting of at least a portion of a work piece based on the positioning of the cutting tool with respect to the work piece. Herein, the work piece comprises a plastic material. The curvy portion is adapted to spin to perform one of cutting and polishing of the work piece based on positioning of at least one of the work piece and the cutting tool with respect to each other.

In an embodiment of the present invention, an apparatus comprising the cutting tool is used for ornamentation of the plastic material. In another embodiment, subsequent to cutting/shaping of the plastic material with diamond cutting tool, the plastic material may undergo metal plating for enhancing aesthetic appearance of the plastic. For metal plating of the plastic, the plastic material may be made rough from the surface where metal needs to be deposited. In an embodiment, after cutting the plastic material, the surface of the plastic may be made rough by using, but not limited to, the diamond cutting tool so as to deposit precious or semi-precious metals, such as copper, chromium, god, silver and the like, thereon. For example, in case of gold plating on any plastic material (that is cut and shaped using diamond cutting tool), the surface of the plastic material may be made rough so as to deposit gold of 8, 9, 14, 18, or 22 karats. Such metal plating is to further enhance the appearance of the plastic material.

Advantageously, the present invention provides a diamond cutting tool having sharp diamond dust for cutting, shaping and polishing a plastic material for ornamentation thereof. The cutting tool is adjustable to a particular position and to an angle with respect to a plastic wok piece that needs to be ornamented. Further, the angle of the cutting tool may be altered with precision. For example, the angle of the cutting tool may be altered by a single degree up to 360 degree. The cutting tool includes a curvy portion having, but not restricted to, a compact mass of diamond dust that is utilized for enhancing smoothness of a surface or a corner of the plastic material. Further, the pointed tip portion is utilized for cutting at least a portion of the plastic material to give shape to the plastic material. Herein, the pointed tip is made up of sharp diamond dust and does not require more pressure to be exerted on the plastic material, and thus makes the cutting and shaping of the plastic material easy. Thus, both cutting and polishing (finishing) is provided by the cutting tool for providing aesthetic appearance to the plastic material. The method of using the diamond cutting tool provides shinier plastic surface to prepare attractive and interesting ornaments. Accordingly, the present invention may be utilized for preparing jewelry or other products from the plastic material.

A more detailed explanation of the invention is provided in the following detailed descriptions and appended claims taken in conjunction with the accompanying drawings.

### BRIEF DESCRIPTION OF THE DRAWINGS

Having thus described the invention in general terms, reference will now be made to the accompanying drawings, which are not necessarily drawn to scale. Further, like reference numerals/letters indicate corresponding parts in various drawings. The diagrams are designed to illustrate the essence of the invention as well as a number of different preferred configurations for this invention. However, they shall not limit the range of possible configurations.

FIG. 1 illustrates a diamond cutting tool, in accordance with an embodiment of the present invention;

FIG. 2 illustrates an exemplary apparatus for ornamentation purpose by utilizing a diamond cutting tool, in accordance with an embodiment of the present invention; and

FIG. 3 illustrates a method of using a diamond cutting tool for plastic ornamentation, in accordance with an embodiment of the present invention.

### DETAILED DESCRIPTION OF THE INVENTION

The following is a detailed description and explanation of the preferred embodiments of the invention and best modes for practicing the invention.

This disclosure describes the subject matter for patenting with specificity to meet statutory requirements. However, the description itself is not intended to limit the scope of this disclosure. The principles described herein may be embodied in many different forms.

An embodiment of the present invention provides a diamond cutting tool and a method of using the diamond cutting tool for ornamentation purpose of a material such as a plastic material. The diamond cutting tool may include a shank and a cutting end. The diamond cutting tool may be used manually or electronically. In an embodiment, the shank may be movably connected to a support bar and the cutting end may be coaxially connected to the shank. The cutting end may have a pointed tip portion configured for smooth cutting of the material that may be positioned below the pointed tip portion of the cutting end. Herein, the smooth cutting may refer to the cutting without requiring an external pressure from the pointed tip portion to the material.

The cut material may require further smoothening of the edges or other surfaces of the material (hereinafter may interchangeably be referred to as “plastic material’ or ‘work piece’). For this, the curvy portion of the cutting end may be utilized to smoothen (or polish) the material or a portion of the material. The cutting tool may be activated one of electronically or manually for cutting and polishing of the material. Activation of the cutting tool enables movement in the cutting tool to perform one or more functionalities for ornamentation of the work piece. Due to this, the cutting end may be moved, over the plastic material to cut the plastic material accordingly. For example, movement of the shank across the length of the support (where the cutting tool may be affixed to) may accordingly cut the material placed below and in contact with the pointed tip portion. Further, the cutting tool may be adjusted manually at a particular position or angle with respect to the plastic material for cutting thereof. Further, the cutting end (of the diamond cutting tool) may spin on activation of the cutting tool to enable surfacing of the material through the curvy portion thereof.

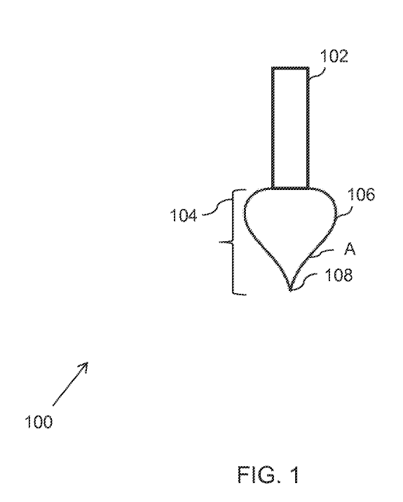

FIG. 1 depicts a diamond cutting tool 100 that may be utilized for ornamentation purposes. The ornamentation may include, but is not limited to, cutting, shaping, and polishing (finishing) of a material. In an embodiment, the material for ornamentation includes a plastic. As depicted, the diamond cutting tool 100 may include a shank 102 that may be adapted to movably affix to a support bar (not shown) for positioning of the cutting tool 100. The support bar may include any bar where the shank 102 can be fixed (or supported). Alternatively, the shank 102 may be moved manually. Further, the cutting tool 100 includes a cutting end 104 that extends longitudinally from the shank and coaxial therewith. The cutting end may be comprised of a compact mass of sharp diamond dust. Further, in an embodiment, the cutting end is comprised of one of a sharp-edged diamond and a material coated with sharp diamond. For example, the cutting tool may be made up of a synthetic diamond or carbon steel coated with diamonds on the sides thereof.

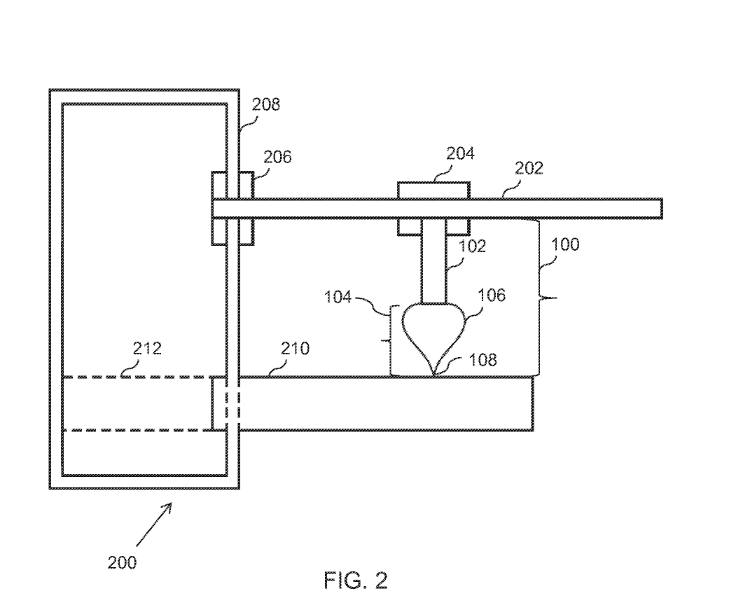

The cutting end 104 may include a curvy portion 106 and a pointed tip portion 108 extending longitudinally from the curvy portion 106. The pointed tip portion 108 may be adapted for cutting of at least a portion of a work piece (as shown in FIG. 2) such as a plastic material. The pointed tip portion 108 may cut the work piece (or at least a portion of the work piece) based on the positioning of the cutting tool 100 with respect to the work piece. In an embodiment, the cutting tool 100 may be positioned by moving along a length of the support bar (not shown) to adjust the curvy portion 106 and the pointed tip portion 108 with respect to the position of the work piece for enabling at least one of cutting, shaping and polishing thereof. Further, in an embodiment, the shaping to the work piece may be provided by cutting through the pointed tip portion 108 or by spinning of the curvy portion 106 against the work piece to peel off an extra material (plastic) or irregular potion of the work piece.

In another embodiment, the cutting tool 100 may be positioned angularly for adjusting to an angle with respect to the work piece for providing an aesthetic appearance to the work piece. For example, the cutting tool 100 may be positioned in a way to enable the work piece to position along with a point such as a point ‘A’, of the curvy portion 106 for polishing (smoothening) or providing shaping to the work piece.

Further, the work piece may be positioned with respect to the cutting end 104. For example, the work piece may be positioned below the pointed tip portion 108 for cutting or shaping purposes. For example, the work piece may be positioned along with a portion of the curvy portion 106 for polishing or finishing of the work piece. Further, in an embodiment, the work piece may also be movable against a direction of spinning of the curvy portion 106 for cutting, shaping or polishing of the work piece through the spinning of the curvy portion 106.

The cutting tool 100 may be activated electronically or manually. On activation of the cutting tool 100, the cutting end 104 (or the curvy portion 106) may be adapted to spin to perform one of cutting, shaping or polishing of the work piece based on positioning of at least one of the work piece and the cutting tool 100 with respect to each other. In an embodiment, the curvy portion 106 may be adapted to spin independent of the pointed tip portion 108 for performing one or more tasks for ornamentation purpose of the work piece.

FIG. 2 illustrates an exemplary apparatus 200 for ornamentation purpose by utilizing a diamond cutting tool, in accordance with an embodiment of the present invention. As shown, the apparatus 200 includes the cutting tool 100 that is affixed to a support bar 202. The cutting tool 100 may be made up of a compact mass of diamond dust having radius in millimeters and thus can be utilized for precision cutting, shaping and polishing of a work piece. The cutting tool 100 is movable through length of the support bar 202 by using an activator mechanism 204. Further, the support bar 202 may be movable perpendicularly from top to bottom or vice versa through an adjusting mechanism 206 fixed to a support structure 208. The support bar 202 is movable through adjusting mechanism 206 to adjust the position of the cutting tool 100 with respect to a position of the work piece such as the work piece 210. The work piece may include, but is not limited to, a plastic material. Further, the cutting tool 100 is movable through the length of the support bar 202 to adjust the position of the cutting tool 100 with respect to the position of the work piece 210.

The work piece 210 may be positioned below and in contact with the cutting tool 100. More specifically, the work piece 210 may be positioned below and in contact with a pointed tip portion 108 for enabling cutting thereof by the cutting tool 100. Furthermore, the work piece 210 may be positioned along the side of the cutting end 104 of the cutting tool 100 for shaping or polishing of the wok piece 210. For example, if the work piece needs to be shaped or polished from one corner thereof then the corner of the work piece 210 may be positioned along the curvy portion 106 of the cutting end 104. In this, the curvy portion 106 may spin to peel off extra or irregular portions of corner edges of the work piece 210 for providing proper shaping to the corner of the work piece 210 or for polishing (finishing) of the corner of the work piece 210.

The cutting tool 100 may be activated electronically through the activator mechanism 204 for enabling the cutting tool 100 to adjust the position or angle thereof. For example, the activator mechanism 204 may enable the cutting tool 100 to move along the length of the support bar 202. Further, the activator mechanism 204 may enable the cutting end 104 to spin on its axis for altering an angle of the cutting tool 100 with respect to positioning of the work piece 210. In an embodiment, the curvy portion 106 may spin independent of the pointed tip portion 108 of the cutting end 104.

Similarly, the work piece 210 may be positioned with respect to the position of the cutting tool 100. In an embodiment, the work piece 210 may be movable longitudinally to adjust the position thereof with respect to the adjustment of the cutting tool 100. For example, the work piece 210 may he movable inside and outside of the support structure 208 as depicted by an area 212 (depicted by a dotted block) wherein the work piece 210 may be adjusted. In an embodiment, the work piece 210 may further be moved perpendicularly up and down through an additional adjusting mechanism (not shown) for the work piece 210 (such as the adjusting mechanism 206 for the support bar 202) of the support structure.

Further, for example, considering that the work piece 210 is a plastic sheet that needs to be cut from the corner to bring out a circular shape from the plastic sheet. In this case, either the cutting tool 100 may be moved, to the corner portion of the work piece 210, by utilizing the activator mechanism 204 or the work piece 210 may be moved inside the support structure 208 to position the corner portion of the work piece 210 below the pointed tip potion 108. Once the cutting tool 100 and the work piece 210 are positioned correctly with respect to each other, the cutting tool 100 may cut the corner portion by utilizing at least one of the sharp curvy portion 106 and the pointed tip portion 108 of the cutting tool 100. Herein, in one embodiment, the work piece 210 may be moved against the direction of spinning of the curvy portion 106 of the cutting tool 100 for shaping/polishing of the work piece 210.

The curvy portion 106 and the pointed tip portion 108 of the cutting tool 100 may be extremely sharp and thus in an embodiment, the pointed tip portion 108 may need not press on a plastic work piece, such as the work piece 210, for cutting or polishing of the work piece 210. For example, the pointed tip portion 108 may cut the work piece 210 by making a light contact with the work piece and moving along the axis of the support bar 202. Thus, the apparatus 200 may facilitate the cutting tool 100 to perform smooth functioning (such as cutting, shaping and polishing) on the work piece 210 for providing an aesthetic appearance to the work piece 210. Further, the cutting tool 100 may be adapted to polish the work piece 210 (i.e., plastic material).

It may be appreciated by a person skilled in the art that the cutting tool 100 is not restricted to perform the above mentioned functionality. Further, the apparatus may be designed with different shape and design to facilitate the cutting tool 100 to perform tasks for ornamentation purpose of the work piece 210 (i.e., the plastic material). For example, the cutting tool 100 may be utilized for metal plating of the work piece 210 (i.e., the plastic material) for enhancing the aesthetic appearance thereof.

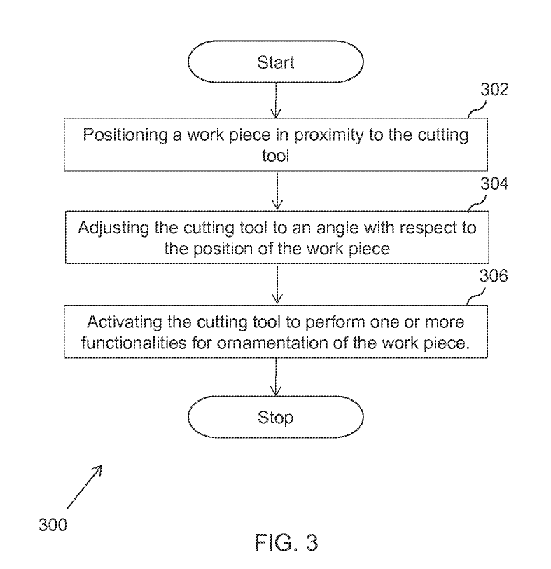

FIG. 3 illustrates a method of using a diamond cutting tool for plastic ornamentation, in accordance with an embodiment of the present invention. The order in which the method is performed is not intended to be construed as limitation, and further any number of steps may be combined in order to implement a method or an alternative method without departing from the scope of this invention. Further, the method 300 may be understood more clearly when read in conjunction with FIGS. 1 and 2.

At step 302, a work piece may be positioned in proximity to the cutting tool, such as the cutting tool 100. The cutting tool may be include, but is not limited to, a shank (such as the shank 102). The diamond cutting tool 100 may be utilized manually or electronically. For example, the shank of the diamond cutting tool 100 may be adapted to affix to a support bar, such as the support bar 202 and a cutting end, such as the cutting end 104. Further, in case of manual usage of the diamond cutting tool 100, the shaft may not be connected to the support bar and may be moved manually for positioning thereof.

The cutting end may extend longitudinally from the shank and arranged coaxially therewith. Further, the cutting end may comprise of a compact mass of sharp diamond dust.

Further, the work piece may be made up of a plastic material, such as a work piece 210 (as described in conjunction with FIG. 2). For example, the work piece may be positioned under the cutting end, such as under a pointed tip portion 108, of the cutting tool for enabling the cutting tool to cut the work piece in different shapes and sizes. Further, the work piece may be positioned along the side of the cutting tool. For example, the work piece may be positioned adjacent to a curvy portion, such as the curvy portion 106, of the cutting tool.

Further, at step 304, the cutting tool may be adjusted to an angle with respect to the position of the work piece. The angle of the cutting tool is adjusted based on a type of cutting or designing required on at least a portion of the work piece. Further, the angle of the cutting tool may be adjusted with respect to the position of the work piece for providing an aesthetic appearance to the work piece. Further, the step 302 and the step 304 may be executed interchangeably to adjust the position of the cutting tool and the work piece with respect to each other.

Once the position and/or angle of the cutting tool and the work piece are adjusted with respect to each other, at step 306, the cutting tool may be activated to perform one or more functionalities for ornamentation of the work piece. For example, the cutting tool may perform cutting and polishing of at least a portion of the work piece. Herein, the cutting may include, but is not limited to, a task of cutting and shaping of the work piece. Further, polishing may include, but is not limited to, scrubbing to make a surface of the work piece smooth and shining.

In an embodiment, the cutting tool may be activated electronically by initiating an electronic mechanism, such as an activator mechanism 204 as described in conjunction with FIG. 2. Such activation of the cutting tool may enable the cutting tool to move across a length of the support bar for positioning thereof. Further, such activation of the cutting tool may enable the cutting end to spin on its axis for performing one of cutting and polishing of a portion of the work piece based on positioning of the cutting tool and the work piece. Alternatively, the cutting tool may be positioned manually for performing one of cutting/shaping and polishing of a portion of the work piece based on the positioning of the cutting tool with respect to the work piece.

Further, in an embodiment, the curvy portion of the cutting tool may spin independently of the pointed tip portion of the cutting end. In an embodiment, spinning of the curvy portion may enable cutting (peeling off) and polishing of a portion of the work piece. For example, a portion of the work piece may be adjusted in proximity to the curvy portion of the cutting end for peeling off a surface of the portion (of the work piece) to an extent. Such peeling off the surface may be utilized for providing shiny surface to the work piece. For example, in case the work piece is a plastic material. The cutting tool may cut the plastic material into a specific shape and size. Further, the shaped material may be polished through the curvy portion of the cutting tool to provide a shiny and an attractive surface to the shaped material. In an embodiment, the cutting tool may be utilized to prepare shiny surfaces to prepare attractive and interesting ornaments such as jewelry.

It may be appreciated by a person skilled in the art that the cutting tool (such as the cutting tool 100) may be utilized with various other arrangements for positioning and activation thereof for ornamentation purposes. Further, the present invention is not limited to preparation of ornaments through plastic material. Further, other metallic and non-metallic components may be designed or ornamented by utilizing the cutting tool.

While the disclosure has been described in connection with what is presently considered to be the most practical and various embodiments, it is to be understood that the disclosure is not to be limited to the disclosed embodiments, but on the contrary, is intended to cover various modifications and equivalent arrangements included within the spirit and scope of the appended claims.

The embodiments as disclosed and described in the application (including any accompanying claims, abstract and drawings) are intended to be illustrative and explanatory of the present inventions. Modifications and variations of the disclosed embodiments, for example, embodiments of the apparatus and tool employed (or to be employed) as well as the method used (or to be used), are possible; all such modifications and variations are intended to be within the scope of the present inventions.

I/we claim:

1. A method of using a cutting tool for ornamentation purpose, the method comprising:
positioning a work piece in proximity to a cutting tool, the cutting tool comprising:
a shank; and
a cutting end comprised of a compact mass of sharp diamond dust, the cutting end extends longitudinally from the shank and coaxial therewith,
activating the cutting tool to perform one of cutting and polishing of at least a portion of the work piece, the work piece comprising a plastic material,
wherein activating the cutting tool enables movement of the cutting tool for positioning thereof, and spinning of the cutting end to perform one of cutting and polishing of a portion of the work piece based on the positioning of the cutting tool.

2. The method of claim 1 further comprising setting the work piece to a suitable position for polishing thereof through a curvy portion of the cutting end of the cutting tool.

3. The method of claim 1 further comprising adjusting the cutting tool to an angle with respect to the position of the work piece for providing an aesthetic appearance to the work piece.

4. The method of claim 1, wherein the cutting tool is activated one of electronically and manually.

5. The method of claim 1, wherein the cutting end is further comprised of one of a sharp-edged diamond and a material coated with sharp diamond.

6. A diamond cutting tool for an ornamentation purpose, the diamond cutting tool comprising:
a shank; and
a cutting end comprised of a compact mass of sharp diamond dust, the cutting end extends longitudinally from the shank and coaxial therewith, the cutting end comprising:
a curvy portion; and
a pointed tip portion extending longitudinally from the curvy portion, the pointed tip portion adapted for cutting of at least a portion of a work piece based on the positioning of the cutting tool with respect to the work piece,
wherein the work piece comprises a plastic material, and
wherein, the curvy portion is adapted to spin to perform one of cutting and polishing of the work piece based on positioning of at least one of the work piece and the cutting tool with respect to each other.

7. The diamond cutting tool of claim 6, wherein the cutting tool is adjustable to an angle with respect to the position of the work piece for providing an aesthetic appearance to the work piece.

8. The diamond cutting tool of claim 6, wherein the cutting tool is activated electronically for enabling the curvy portion to spin to perform one of cutting and polishing of the work piece.

9. The diamond cutting tool of claim 6, wherein the cutting end is further comprised of one of a sharp-edged diamond and a material coated with sharp diamond.

10. The diamond cutting tool of claim 6, wherein the cutting tool is movable to adjust the curvy portion and the pointed tip portion with respect to the position of the work piece for enabling at least one of cutting and polishing thereof.
